(19) United States
(12) Patent Application Publication
(10) Pub. No.: US 2021/0241580 A1
(43) Pub. Date: Aug. 5, 2021

(54) PLAY BY PLAY WAGERING THROUGH WEARABLE DEVICE

(71) Applicant: AdrenalineIP, Washington, DC (US)

(72) Inventors: Casey Alexander HUKE, Washington, DC (US); John CRONIN, Jericho, VT (US); Michael D'ANDREA, Burlington, VT (US)

(73) Assignee: AdrenalineIP, Washington, DC (US)

(21) Appl. No.: 16/951,174

(22) Filed: Nov. 18, 2020

Related U.S. Application Data
(60) Provisional application No. 62/970,286, filed on Feb. 5, 2020.

(51) Int. Cl. G07F 17/32; G06Q 50/34; G06F 1/16

(52) U.S. Cl. CPC G07F 17/3288; G07F 17/3218; G06F 1/163; G06Q 50/34; G07F 17/323

(57) ABSTRACT

A system for providing play by play wagering to a user who is physically at a sporting event. The user has a wearable device that is used to capture game data, a local program calculates the odds of different event outcomes in the game based on observed game play and situation. The user can place their wager through the wearable device interface. The sensors on the wearable device, such as camera or microphone, are used to determine if the user won or lost their wager.

### FIELD

The embodiments generally relate to play by play sports wagering through mobile and wearable devices, and, in particular, to wagering done on a sporting event that the user is attending.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

This invention deals with capturing play data and communicating it to the user's mobile device for play by play betting can be problematic when the user is at the live game. The large number of people in the stadium makes reliable bandwidth problematic and that could cost wagering providers potential revenue with missed opportunities to bet.

### SUMMARY

A method, system, and apparatus for wagering using a wearable device. In one embodiment, a wagering game system can include a historical play database from which the frequency of each event outcome in the historical play database can be filtered for an in-game context of each event; and a wearable device comprising a wearable device user interface and at least one sensor that captures in-game information, wherein the at least one sensor on the wearable device captures in-game data to determine a situation and context of a given event, and a calculation of odds for a variety of outcomes for a next event based upon historical play data and a presentation of the odds as potential wagers on the wearable device user interface.

Another embodiment relates to a method for wagering on a live event, including capturing data from a live event on one or more sensors of a wearable device; determining if the captured data exceeds a threshold value; calculating odds for a next event if the captured data exceeds a threshold value; displaying a wagering option for a next event on the wearable device; and accepting an input on the wearable device for a wager.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for play by play wager wagering through a wearable device, according to an embodiment.

FIG. 2 illustrates a base module, according to an embodiment.

FIG. 3 illustrates a data capture module, according to an embodiment.

FIG. 4 illustrates an odds calculation module, according to an embodiment.

FIG. 5 illustrates a wager module, according to an embodiment.

FIG. 6 illustrates a wallet database, according to an embodiment.

FIG. 7 illustrates a data feed database, according to an embodiment.

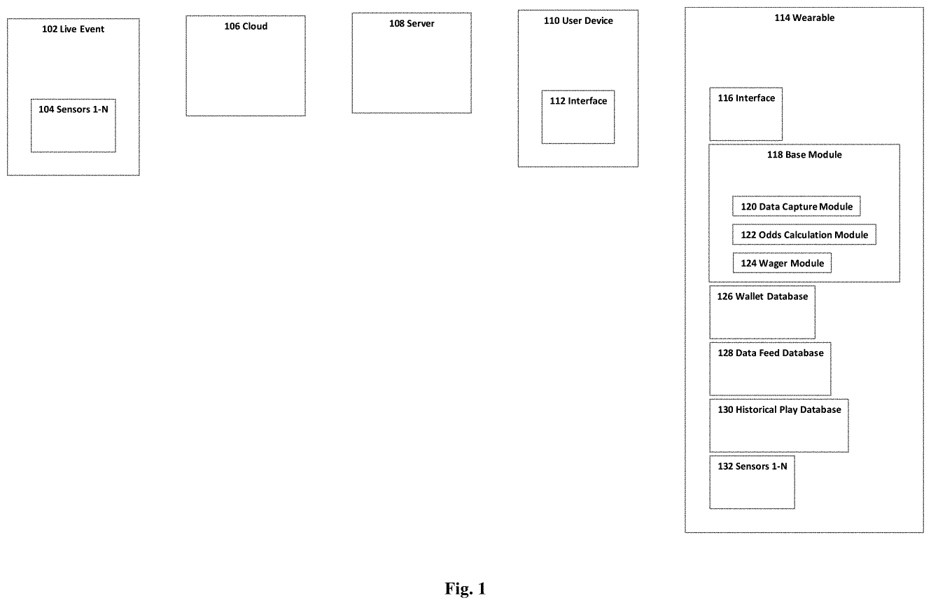

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

This is a system for play by play wagering through a wearable device. This system includes of a live event 102, for example a sporting event such as a football game, basketball game, baseball game, hockey game, tennis match, golf tournament, etc., in element 102. The system includes a plurality of sensors 104 that may be used such as motion sensors, temperature sensors, humidity sensors, cameras such as an RGB-D Camera which is a digital camera providing color (RGB) and depth information for every pixel in an image, microphones, radio-frequency receiver, a thermal imager, a radar device, a lidar device, an ultrasound device, a speaker, etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball, in element 104. The system also includes a cloud 106 or communication network may be a wired and/or a wireless network. A wireless communication network using communication techniques, included by limited to Visible Light Communication (VLC), Worldwide Interoperability for Microwave Access (WiMAX), Long Term Evolution (LTE), Wireless Local Area Network (WLAN), Infrared (IR) communication. The wireless communication network may allow ubiquitous access to shared pools of configurable system resources and higher-level services that can be rapidly provisioned with minimal management effort, often over Internet and relies on sharing of resources to achieve coherence and economies of scale. The wireless communication could also include third-party clouds to enable organizations to focus on their core businesses instead of expending resources on computer infrastructure and maintenance. The cloud may be communicatively coupled to server 108 which may perform real time analysis on the type of play and the result of the play. The cloud may also be synchronized with game situational data, such as the time of the game, the score, location on the field, weather conditions, and the like which may affect the choice of play utilized. In other exemplary embodiments, the cloud may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The system may include a server 108 which may perform real time analysis on the type of play and the result of a play or action. The server 108 (or cloud 106) may also be synchronized with game situational data, such as the time of the game, the score, location on the field, weather conditions, and the like which may affect the choice of play utilized. For example, in other exemplary embodiments, server 108 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein, in element 108. A user device such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In this invention the user device could be an optional component and would be utilized in a situation in which the paired wearable device is utilizing the user device as additional memory or computing power or connection to the Internet, in element 110. The interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface, in element 112. The wearable device is a category of electronic devices that can be worn on the body as accessories, such as a smart watch or smart glass or a device embedded in clothing or a device implanted in the user's body or a device tattooed on the skin. The devices are hands-free devices with practical uses, powered by microprocessors and enhanced with the ability to send and receive data via the Internet. Some examples of wearable devices include smart watches, and smart glasses, in element 114. The interface(s) may either accept inputs from users or provide outputs to the users, or may perform both the actions. In one case, a user can interact with the interface(s) using one or more user-interactive objects and devices. Examples include the touch screen on a smart watch or the near eye display on smart glasses, in element 116. The base module allows the user to log into the system, prompts the data capture module to determine game and play information, prompts the odds calculation module to calculate the odds of various play results based on the context of the situation determined by the data capture module, prompts the wager module to collect the user's wager, and prompts the data capture module again to collect play results that are then compared to the wager and the wallet database is updated based on the outcome of the wager, in element 118. The data capture module determines which sensors are available on the wearable device, such as a microphone or video feed, determines what relevant data points can be captured by the available sensor(s), monitors for those data points and returns play results based upon the collected data, in element 120. The odds calculation module calculates the odds of each potential play outcome based upon the historical play data related to the teams involved and the context of the game, in element 122. The wager module presents available wagers to the user through the wearable interface, polls for the user's selected wager and returns that selection to the base module, in element 124. The wallet database tracks the balance of dollars or points the user has in their account, and updates that balance after the result of each wager, in element 126. The data feed database contains all sensor types the system can utilize from a wearable device, in this example a microphone or video feed, and what relevant data points can be captured by each sensor type so as to determine information about the game being viewed, in element 128. The historical play database, in this embodiment is located on the wearable device, but based upon storage space, processing power and available bandwidth, can be located on the user device or the cloud server. The database contains the historical play data for the relevant sport, in element 130. The sensors 1-n are those sensors in the wearable device that can be used to collect information on the game that can be used to determine the play results and context, in element 132.

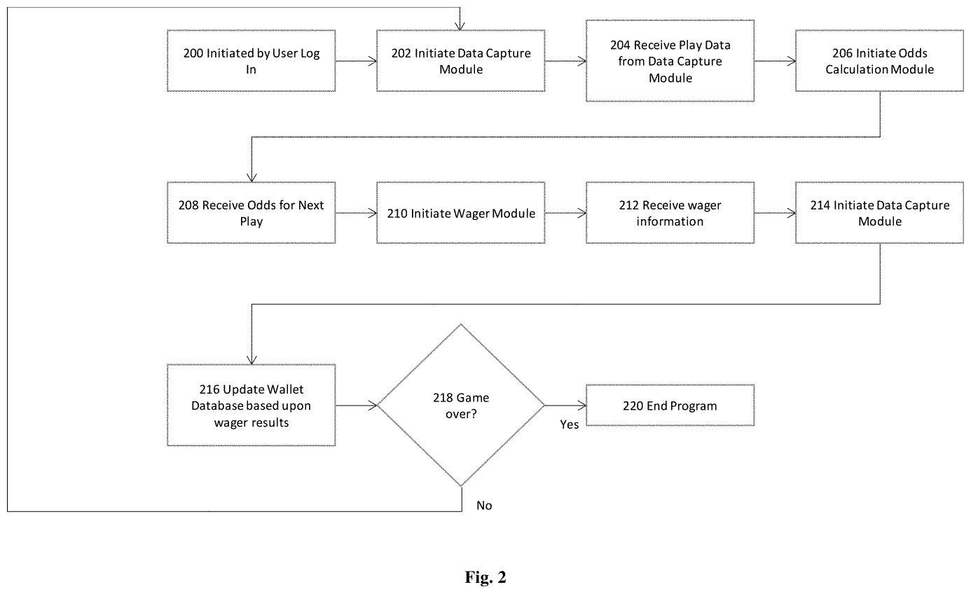

Functioning of the base module will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module. The base module begins with the user logging into the system, typically via an app on their wearable device, at step 200. In some embodiments the base module can be located on the user's mobile device and the data capture and wager interaction is done on a paired wearable device, such as smart glasses, or a smart watch. The base module first initiates the data capture module, to determine which game the user is at, and then to monitor for relevant data points to identify the action in the game at step 202. Play data is then returned from the data capture module. Play data can be any sensor data that indicates anything about the live game, such as , but not limited to audio or visual data that indicates “actions” , “sides”, “event” data, “total” data, “listed pitchers”, specific players, whistles, fouls, touchdowns, goals, yardage, player error, etc., at step 204. The base module then initiates the odds calculation module to calculate the odds on the next play, at step 206. The odds for potential outcomes of the next play are retuned by the odds calculation module, at step 208. The base module then initiates the wager module, to present available wagers to the user and collect data on any wagers they select, at step 210. Wager selection information is then returned by the wager module. Wager selection information can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 212. The base module then initiates the data capture module again to get play result information to compare to the wager selection returned by the wager module, at step 214. The play result information is received from the data capture module, and the information in the wallet database is updated based on the outcome of the wager, at step 216. The module then determines if the game is over based upon the previous play results, at step 218. If the game is not over, return to step 202. If the game is over, end program. It should be noted that the base module can be made available for access , reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 220.

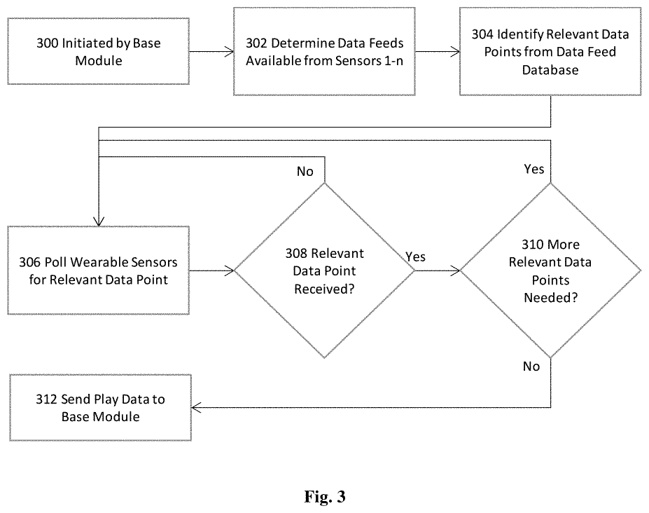

Functioning of the data capture module will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the data capture module. The process begins with receiving a prompt from the base module at step 300. The data capture module first determines what data feed(s) are available from the user's wearable device, such as a microphone or video feed, at step 302. Based upon the data feed(s) available from sensor 1-n on the user's wearable device, identify from the data feed database, what the relevant datapoints to search for in the data feed from each available sensor, at step 304. For example, if the user's wearable device is a pair of smart glasses with both an audio and video feed, the system can both listen for the referee's whistle with the microphone, to indicate the end of the play, or rely on the video feed to see the down marker change, or the referee raise his arm to indicate the spot of the new line of scrimmage. The data capture module then begins to poll the data feeds from the identified sensors in the wearable device for relevant data points, at step 306. The data capture module then determines if a relevant data point has been received, at step 308. When no relevant data point is received, the data capture module returns to polling at step 306. When a relevant data point is received, the data capture module determines if any additional data points are needed to determine the play results, at step 310. For example, the microphone provides the relevant data point of the referee's whistle, indicating the current play has ended. The data capture module would then need either the public announcer audio to determine yards gained, or the video feed of the referee's raised arm indicating the new line of scrimmage. Once enough relevant data points are received to identify the play, the play data is sent to the base module, at step 312.

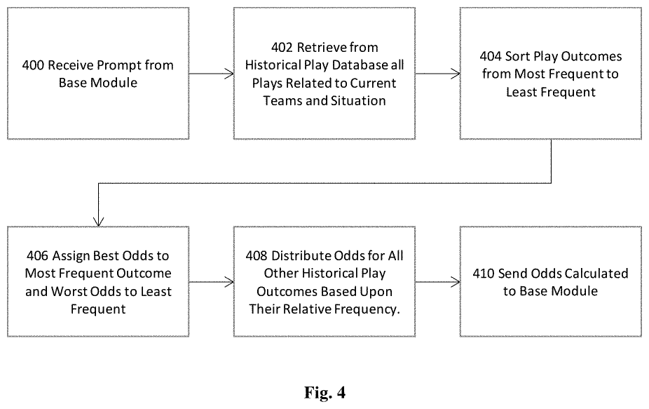

Functioning of the odds capture module will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure shows the odds capture module. The process begins with a prompt from the base module at step 400. The odds calculation module will then retrieve from the historical play database all historical play data related to the teams in the current game, at step 402. The odds calculation module then filters the retrieved plays based on the current context, such as which side is on offense, the current score, down and distance, weather, etc. The remaining plays are then sorted based on their frequency in the current context, at step 404. In one example criteria for this invention is for sorting and filtering plays specific to American football. These example criteria would be specific to the sport in question. The odds are assigned to the filtered play results based upon their historical frequency, or one of the other means of assigning odds that are well known in the art. The best odds are assigned to the most frequent outcome, and the longest odds are assigned to the least frequent outcome, at step 406. The odds for the plays between the most frequent and least frequent are assigned across the play distribution between the best and longest odds, at step 408. The calculated odds are then sent to the base module at step 410.

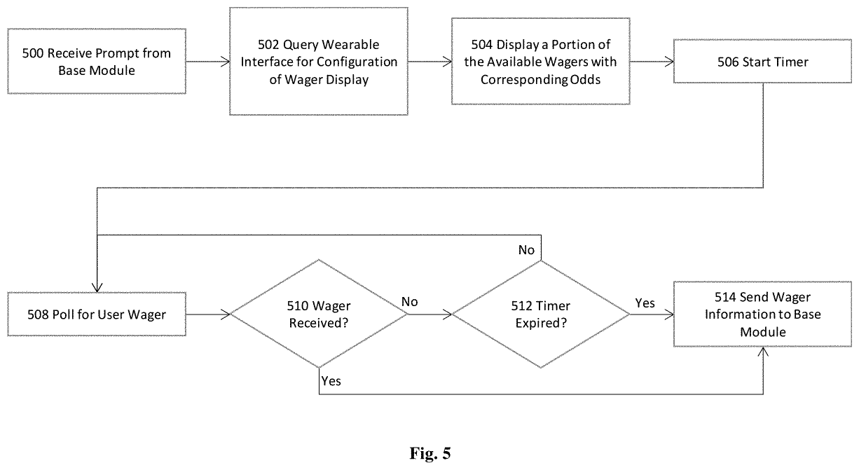

Functioning of the wager module will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure shows the wager module. The process begins with a prompt from the base module at step 500. The wager module then queries the wearable device interface for configuration information, at step 502. The configuration information received from the wearable device interface will determine how many wagers can be presented to the user, and the format in which they should be presented. The wager module then displays a portion of the available wagers, in this embodiment the wagers with the best odds are displayed, at step 504. In other embodiments the wagers displayed could be based upon other factors, such as user history or preferences. The wager module then begins a timer, at step 506. The timer would be customized based on the pace of play in a given game or sport. In this embodiment the timer is set to 20 seconds. This is because the sport in the example is American football. With a 40 second play clock, it is a reasonable time to allow the user to consider a wager, but not too long so as to have wagers after the start of the play. Wagers submitted after the start of the play are invalid, but the timer is a method of allowing the software to go back to the data capture module. Once the timer is started, the module polls the wearable device interface for a wager by the user, at step 508. The wager module then determines if a wager was received, at step 510. If a wager is received, the module returns that wager information to the base module. If no wager has been received, the wager module polls the timer to determine if it has reached the threshold for the sport in question at step 512. If the timer has not expired, the wager module returns to polling the wearable interface for a wager. Once a wager is received or the timer has reached the predetermined threshold, the wager module returns that information to the base module at step 514.

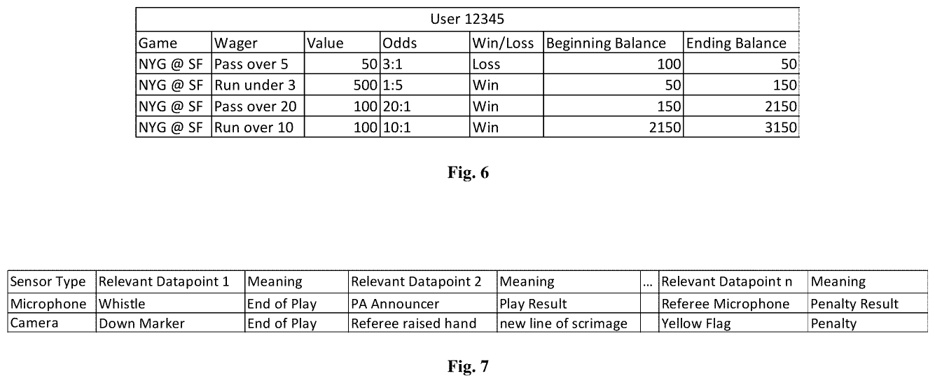

Functioning of the wallet database will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure shows the wallet database. The database contains the user's balance, in real currency or points, each wager the user makes, the results and the new balance in their account. Each user has their own table in the database. The first column records the game on which the wager was made. The second column records the wager the user made, such as betting that the next play will be a pass play that gains more than 20 yards. The third column records the amount the user wagered on the play. The fourth column records the odds on the wager the user made, such as 2:1. The fifth column records if the user won or lost the bet. The sixth column records the user's account balance before the wager. The seventh column contains the user's account balance after the results of the wager are calculated in element 600.

Functioning of the data feed database will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure shows the data feed database. The database contains the sensor types that can be used by the system to collect information about a play, such as, when it is complete and the results. The first column describes the sensor type, such as a microphone or a camera. The second column lists the first piece of relevant data that sensor is looking for, such as, the whistle for the microphone. The third column contains the meaning of the relevant data point. For example, the referee's whistle will indicate to the microphone that the play has been completed. This two column pattern of relevant data points and their meanings repeats for all relevant data points that can be collected by each sensor, in element 700.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A wagering game system comprising:
a historical play database from which the frequency of each event outcome in the historical play database can be filtered for an in-game context of each event; and
a wearable device comprising a wearable device user interface and at least one sensor that captures in-game information, wherein the at least one sensor on the wearable device captures in-game data to determine a situation and context of a given event, and
a calculation of odds for a variety of outcomes for a next event based upon historical play data and a presentation of the odds as potential wagers on the wearable device user interface.

2. The system of claim 1, wherein the at least one sensor comprises at least one of a microphone and a camera.

3. The system of claim 1, further comprising a data capture module that determines relevant data points that can be captured by the at least one sensor on the wearable device.

4. The system of claim 1, further comprising a mobile device which is communicatively paired with the wearable device.

5. The system of claim 4, wherein the wearable device is at least one of smart glasses and a smart watch.

6. The system of claim 4, further comprising a base module on the mobile device that initiates the one or more sensors on the wearable device to capture data.

7. The system of claim 4, further comprising an odds calculation module that generates odds on the next outcome following receipt of the captured data.

8. The system of claim 7, wherein the base module initiates the one or more sensors on the wearable device to capture data at a conclusion of the next event.

9. The system of claim 6, wherein the base module queries the wearable device to determine types of the at least one sensor and data which can be collected by the at least one sensor.

10. The system of claim 7, wherein the odds calculation module is initiated following receipt of a number of data points exceeding a threshold value, as determined by a data capture module.

11. A method for wagering on a live event, comprising:
capturing data from a live event on one or more sensors of a wearable device;
determining if the captured data exceeds a threshold value;
calculating odds for a next event if the captured data exceeds a threshold value;
displaying a wagering option for a next event on the wearable device; and
accepting an input on the wearable device for a wager.

12. The method of claim 11, further comprising pairing the wearable device to a mobile device.

13. The method of claim 11, further comprising receiving a signal on the wearable device to initiate capturing data on a next event and then capturing data on the next event.

14. The method of claim 13, wherein the signal is received from the mobile device.

15. The method of claim 13, further comprising comparing the captured data from the live event to data in a historical database to calculate the odds for the next event.

16. The method of claim 11, further comprising determining if the wager is successful based on an analysis of the captured data from the next event.
